(19) United States
(12) Patent Application Publication
(10) Pub. No.: US 2002/0089820 A1
(43) Pub. Date: Jul. 11, 2002

(54) Stackable peripheral housing

(76) Inventor: Pierre Abboud, Encino, CA (US)

Correspondence Address: Michael S. Doll, 200 Oceangate Suite 1550, Long Beach, CA, 90802, US

(21) Appl. No.: 09/757,243

(22) Filed: Jan. 8, 2001

(51) Int. Cl. G06F 1/16

(52) U.S. Cl. 361/685; 361/683

(57) ABSTRACT

A stackable external housing having a modular design for encasing a variety of hardware peripherals within an interior compartment formed by releasably engaging upper and lower halves that receive the hardware peripheral and include several features for nesting adjacent housings against one another including upper and lower interface connector openings and complementary top and bottom surface contours.

This is continuation-in-part of co-pending U.S. Ser. No. 09/______ , entitled, Modular External Peripheral Housing, filed on Nov. 13, 2000, which in turn is a continuation of U.S. Pat. No. 6,147,859, entitled, Modular External Peripheral Housing, filed on Aug. 18, 1999, which are hereby incorporated by reference in their entirety.

### BACKGROUND OF THE INVENTION

1. Field of the Invention

The invention relates generally to housings for electrical components and more specifically, to housings for external computer peripherals.

2. Description of the Prior Art

The popularity of external hardware peripheral equipment for computers arises in part from the convenience of merely plugging the peripheral into the computer via an interface cable thereby saving the user from opening up the casing of the computer. In addition, many external devices are designed to be plugged into a main hub and would otherwise be restricted by the internal size and number of internal sockets of the main processor housing. The main focus of hardware designers working on these devices has been improving the technical performance of the internal components. As a result, limited forethought has been introduced into the external casing of the device.

Currently, typical hardware peripherals such as drives of the CD-ROM, CD-R, CD-RW, Hard, Floppy, DVD, Tape, WORM, Jaz, and Zip variety have their main working components encased in a close fitting metallic casing for internal use within a computer. To be transformed into an external device, the drive is typically enclosed in a second slightly larger casing. This external casing is typically metal and is generally held together by threaded fasteners.

In addition to the drive, the external casing typically accommodates a cooling fan, a power supply, and an interface connector specific to the internal device. In other words, the external casing is typically designed and limited to the incorporation of an interface panel for a specific interface connector such as a Small Computer Serial Interface (SCSI), parallel, or Universal Serial Bus (USB) connector. The casing is not readily adapted to alternate connectors and a differently configured housing must be procured or developed. An internal interface cable connects the drive to the interface connector at the back of the casing. An external cable is then used to connect the external drive to a desired port on the rear panel of a central processor. If multiple drives are required, then a series of cables is required or a continuous cable having a number of interface connectors is required adding to the overall space required and complexity of the set up.

Other external casings are available including towers or cabinets designed to hold multiple drive units. Typically, the drives are vertically aligned on shelves or brackets throughout the cabinet. This type of external casing is also metal and sometimes incorporates multiple fans to cool multiple drive units.

Several drawbacks are readily apparent from the current external casing designs. The metallic casings add an unnecessary amount of significant weight to the external peripheral. Since structural support is not a major design concern, the overall weight of the product could be reduced. The casings are also generally secured by threaded fasteners which increases both assembly time and deassembly time.

The incorporation of a fan for cooling the drive adds significant weight to the product and contributes to a reduced meantime between failure because the fan is typically the first component to fail.

Conventional external peripheral casings are tailored to a particular model or manufacture and typically tightly enclose the internal unit. The casings typically only stack due to being configured in a generally rectangular shape with opposing top and bottom planar surfaces. Such casings position the interface panel on the back wall of the casing. Thus, a number of interface connectors and the appropriate cable length is required to a connect a multiple stacked assembly. Another notable design limitation is that the individual peripherals, when stacked, typically do not resist motion in relation to one another and are easily misaligned due to the lack of motion impediments on their respective planar surfaces.

One such housing overcoming some of the problems is described in U.S. Pat. No. 6,147,859 which has been assigned to the present applicant. Although such housings are stackable in relation to one another, there is a space between the housings that increases the distance between respective interface connectors which in turn increases the length of the connector cables required to connect each peripheral to a main computer.

In addition, conventional casings are typically rectangular and are restricted to being placed on a stable flat, horizontal surface and are not readily portable. In particular, limited design emphasis has been placed on the external surface of the design casing to provide for any portability.

What is needed and heretofore unavailable is an easy to assemble, modular external casing made of a light weight material that facilitates different sized drives and provides an improved stacking relationship to other housings to remove the requirement for lengthy cable interface connectors as well as improved portability and interface with a variety of digital data processing and generating devices.

### SUMMARY OF THE INVENTION

In accordance with a preferred embodiment of the present invention, a nestable external housing for encasing an electrical component such as a computer hardware peripheral is provided and includes an upper half having a top portion flanked by downwardly projecting side walls that include a first fastener element. The top portion includes a forward region and an upwardly raised rear connector section defining a slot therein for receipt of a first interface connector. A lower half includes a support surface for supporting the peripheral and upwardly projecting side walls that include a second fastener element for releasable engagement with the first fastener element. The lower half further includes a recessed connector section defining an aperture for receipt of a complementary second interface connector. The two halves when releasably fastened together form an interior compartment for receipt of the peripheral device. The top and bottom portions of each housing are complementary such that additional housings of a like configuration may be stacked on top of one another to lie flush on top of one another and adjacent first and second interface connectors of respective adjacent housings may be connected to form a multiple peripheral stack without using intermediate interface cables between interface connectors.

Another feature of the present invention is a housing that is constructed with an accessory attachment which may be attached to a support device having a suction pad for placement on inclined surfaces.

Yet another feature is the provision of a circuit board anchor projecting from inwardly from the top and bottom surfaces to pass through an aperture in a circuit board extending from the hardware peripheral and releasably engage one another to stabilize the hardware peripheral within the housing.

Other features and advantages of the present invention will become more apparent from the following detailed description of the invention, when taken in conjunction with the accompanying exemplary drawings.

### BRIEF DESCRIPTION OF THE DRAWINGS

FIG. 1 is a rear perspective view of a device embodying the present invention;

FIG. 2 is a top view, in enlarged scale, of the device shown in FIG. 1;

FIG. 3 is a bottom view, in enlarged scale, of the device shown in FIG. 1;

FIG. 4 is a transverse sectional view taken along lines 4-4 as shown in FIG. 2;

FIG. 5 is a transverse sectional view taken along lines 5-5 as shown in FIG. 3;

FIG. 6 is a forward perspective view with cutaway sections, in enlarged scale, of the top half of the device illustrated in FIG. 1;

FIG. 7 is a forward perspective view with a cutaway section, in enlarged scale, of the bottom half of the device illustrated in FIG. 1;

FIG. 8 is a rear perspective of two such devices as depicted in FIG. 1 illustrating a stacked arrangement;

FIG. 9 is a reverse longitudinal sectional view taken along lines 9-9 as shown in FIG. 8;

FIG. 10 is a bottom view of a second embodiment of the present invention illustrating the device illustrated in FIG. 1 with an attachment;

FIG. 11 is a perspective view, in reduced scale, of the attachment illustrated in FIG. 10;

FIG. 12 is a longitudinal sectional view, taken along lines 12-12 as shown in FIG. 10; and

FIG. 13 is a side view of a belt clip accessory;

FIG. 14 is a top view, in enlarged scale, of the belt clip accessory illustrated in FIG. 13;

FIG. 15 is a top view of an alternative housing embodiment;

FIG. 16 is a side view of the housing illustrated in FIG. 15;

FIG. 17 is a longitudinal cross sectional view of a second alternative housing embodiment;

FIG. 18 is a plan view of an interface connector for use with the housing illustrated in FIG. 17;

FIG. 19 is a rear view of the top half of the shell insert;

FIG. 20 is a top view of the insert depicted in FIG. 19;

FIG. 21 is a rear view of the bottom half of the shell insert; and

FIG. 22 is a top view of the shell insert depicted in FIG. 21.

Numerous advantages and aspects of the invention will be apparent to those skilled in the art upon consideration of the following detailed description which generally provides illustrations of the invention in its presently preferred embodiments.

### DETAILED DESCRIPTION OF THE PREFERRED EMBODIMENT

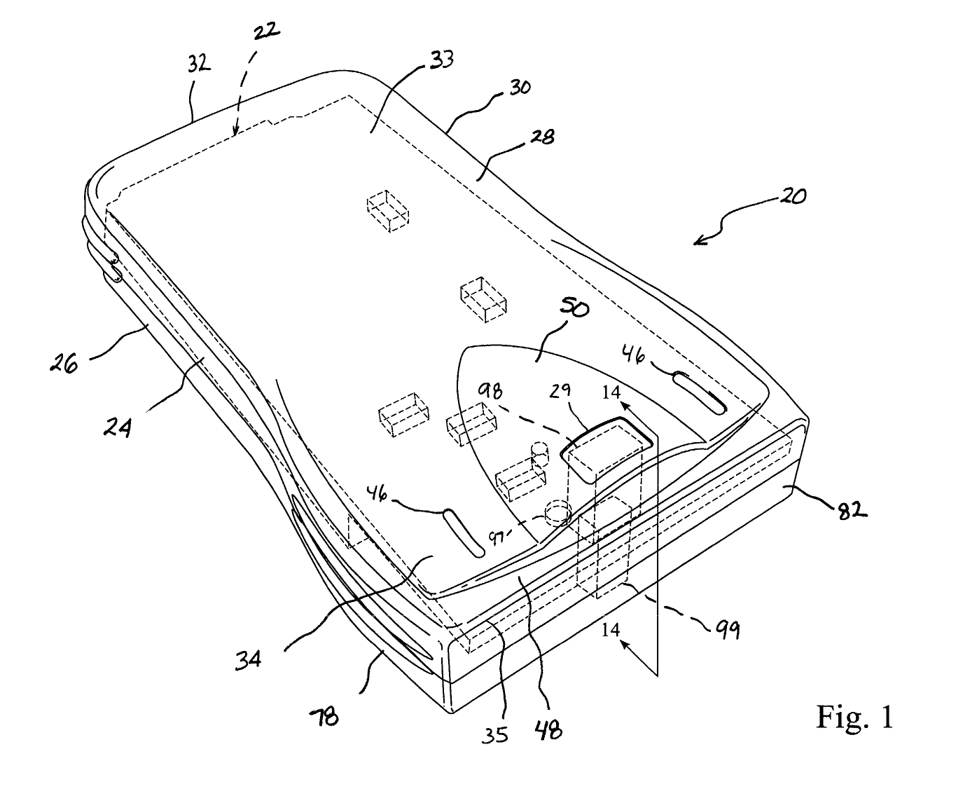

Referring now to FIG. 1, an external housing or casing, generally designated 20, is provided for use in conjunction with a hardware peripheral 22 such as a hard drive unit having oppositely projecting complementary interface connectors, as exemplified by phantom lines, and constructed to be placed in a stackable arrangement with housings of a like configuration. One such interface connector is described in U.S. Ser. No. ______ , entitled Interface Connector for a Hardware Device, filed on Jan. 8, 2001 and is hereby incorporated by reference in its entirety. Such housing generally comprises an upper half 24 and a lower half 26 made of a rigid plastic material and constructed to snap together to form an interior compartment 28 dimensioned to receive and encase the peripheral 22. A top half access port 29 and an opposing bottom half access port 31 provide access to the hardware peripheral's interface connectors such that the hardware peripheral 22 may be connected to other peripherals or a computer using like configured connectors and or interface connector cables. The housing is symmetrical about a longitudinal centerline.

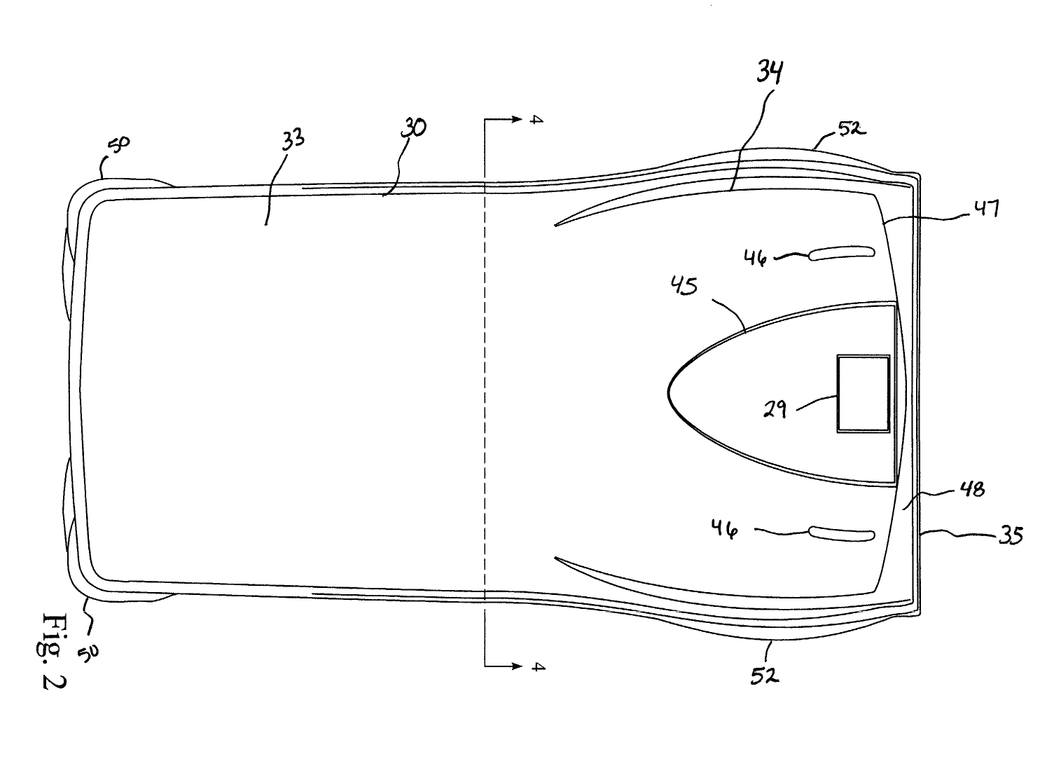

Referring now to FIGS. 1-2, 4, and 6, the upper half 24 is generally an inverted channel shaped cover formed with a top portion 30 having a forward leading edge 32 having rounded lateral extremities bordering a generally planar forward section 33 which gradually transitions in the longitudinal direction to a raised and contoured rear connector section 34 which terminates in a planar trailing edge 35. For purposes of illustration, the longitudinal direction is defined as a projection from a midpoint of the leading edge 32 to the midpoint of the trailing edge 35. Each section is proportioned in length to comprise about fifty percent of the entire length of the top half. The rear connector section 34 is enlarged in the transverse cross section when compared to the planar forward section 33. A pair of downwardly projecting side walls 42 flank the top portion 30. From the leading edge 32, the side walls 42 project in a linear fashion to an outwardly and rearwardly curved surface such that the side wall diverge at an intermediate point along the length of the side walls 42. As illustrated in FIG. 2, the side walls converge again as they approach the trailing edge 35. The lowermost extremity of the side walls 42 forms a lower edge 44 that defines the lower boundary of the channel shaped top half 24.

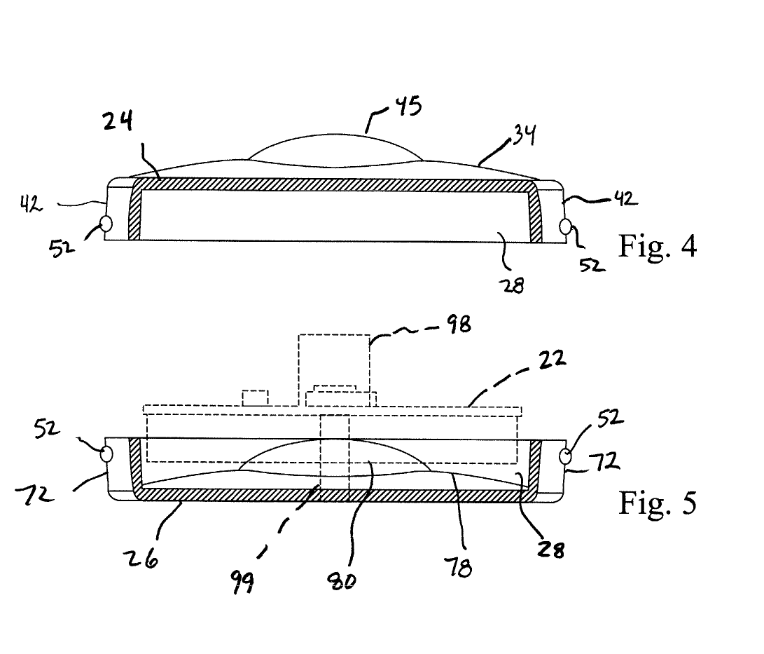

The exterior surface of the top portion 40 includes several features which contribute to the stackable nature of the housing 20. The rear connector section 34 is generally arcuately shaped when viewed in transverse cross section (FIG. 4). Centrally disposed within the rear connector section 34 is a semi-elliptical shaped dome 45 which includes the top half access port 29. The top access port in the form of a rectangular female connector aperture providing access to an interface connector in the interior of the housing. The apex of the dome when viewed from above points inwardly toward the forward planar section 33 of the housing.

Spaced apart from either lateral side of the dome 45 are a pair of retention grooves 46 which recess into the rear connector section. The are generally rectangularly shaped with rounded edges and are slightly concave shaped with respect to the longitudinal centerline. The curvature of the rear connector section 34 and recessed grooves 46 cooperate to inhibit a like configured housing from sliding relative to an adjacently stacked housing as will be described below. The rear edge 47 of the connector section 34 is generally concave when viewed from the transverse centerline of the housing and is recessed inwardly from the trailing edge 35 to form a ledge or step 48 which can partially support a similarly configured housing stacked on top. A set of raised forward bumpers 50 and rear bumpers 52 are advantageously located at points along the side walls 42 where impact forces to the housing are likely to take place. The forward bumpers wrap around the leading edge 32 and onto the side walls 42. The rear bumpers are positioned along the length of the enlarged curved section of the side walls 42 in the rear connector 34 of the housing 20. The raised bumpers further provide grippable ridges facilitating the handling of the housing.

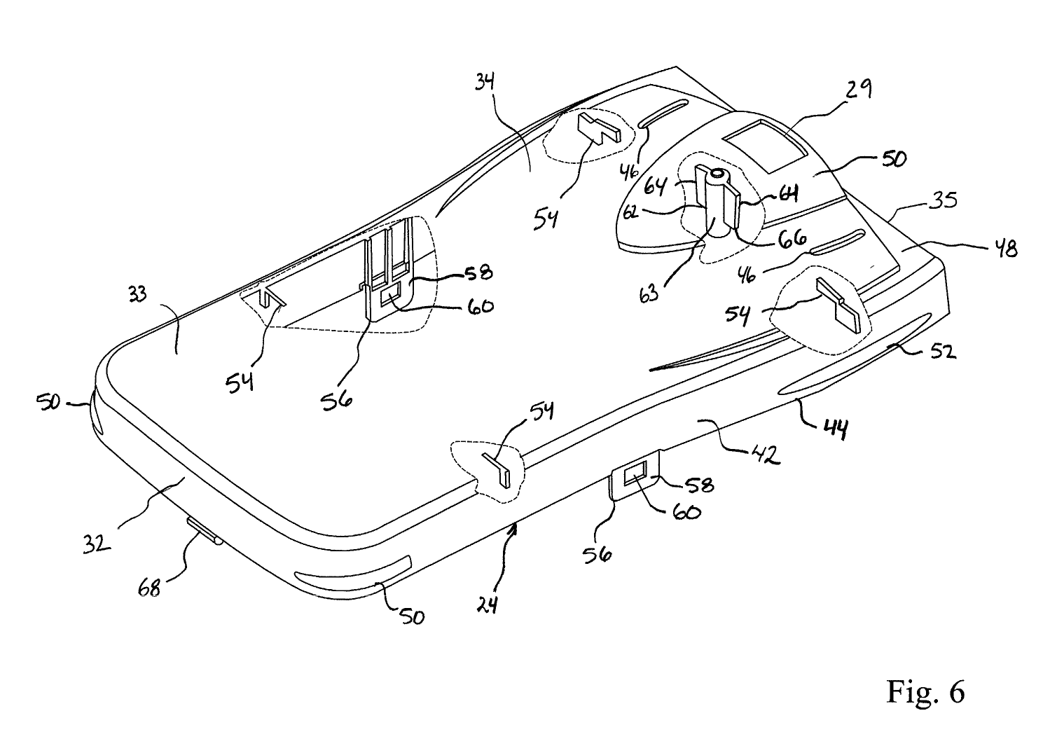

Turning now to FIG. 6, the interior surface of the upper half 24 includes a set of four substantially L-shaped guides 54 for disposition against the upper surface of a hardware peripheral 22 to stabilize the peripheral in the transverse direction. Each guide projects inwardly from a side wall 42 and includes a downwardly projecting leg. The downwardly projecting leg of the guides rests against the sides of the hardware peripheral 22 and function to inhibit sideways movement of the drive within the compartment 28.

With continued reference to FIG. 6, a pair of fasteners 56 are formed on the interior of each side wall 42 and project downwardly to extend below the lower edge or rim 44 of the upper half 24. Each fastener includes a tab 58 in the form of a plastic loop project downwardly from the lower edge 44 of the upper half 24 at an intermediate point along the side walls 42. A fastener receiving slot 60 is formed in each tab 58 for receipt of a complementary fastener in the bottom half 26 as will be discussed below. A forward locking tab 68 projects below the lower edge 44 of the upper half 24 and is positioned centrally along the front wall 70 of the upper half. Such locking tab is in the form of a resilient hook. The fasteners 56 and 68 are formed of a resilient material allowing the fasteners 56 to be pressed inwardly and snap back outwardly to mate with a complementary fastener on the bottom half 26 of the housing 20.

Another feature of the interior surface of the upper half 24 of the housing is a hardware peripheral male anchor 62. Such male anchor projects inwardly from the interior top surface of the upper half 24 of the housing. The male anchor includes a cylindrical hollow post 63 interposed between two laterally projecting flanges 64 which provide additional strength to the post and form a lower abutment 66 to rest on a portion of the hardware peripheral to further inhibit upward movement of the hardware peripheral 22 within the housing 20.

Turning now to FIGS. 1, 3, 5, and 7, the lower half 26 of the housing 20 is also generally channel shaped with a central support tray 70 adjoined at the sides to a pair of upwardly projecting side walls 72 that terminate in an upper rim 74 which defines the upper boundary of the lower half. The outer surface of the lower half 26 is generally configured to form a complementary surface to the top surface of the upper half 24 of the housing such that when the two are placed in an abutting relationship, they will lie flush against one another. Thus, the central support tray is generally planar in the forward section 76 and arcuately contoured in the rear section 78. The exterior surface of the lower half further includes an inverted connector dome 80 disposed centrally in the transverse direction and proximate the rear wall 82 of the lower half 26 of the housing 20. Within the dome surface is a male connector port 31 in the form of a rectangular opening providing access to the interior of the housing 20 from the lower half and dimensioned to receive a male connector of the hardware peripheral 22 projecting therethrough. A pair of spaced apart ridges 83 on either lateral side of the inverted dome 80 protrudes from the exterior surface of the contoured rear section 78. Such ridges are configured to align with and nest within the recessed grooves 46 on the exterior surface of the upper half 24 when adajcent housings are stacked together (FIG. 8). The depth of the grooves 46 prevents the ridges and thus the adjacent stacked housing from inadvertently sliding off the lower housing.

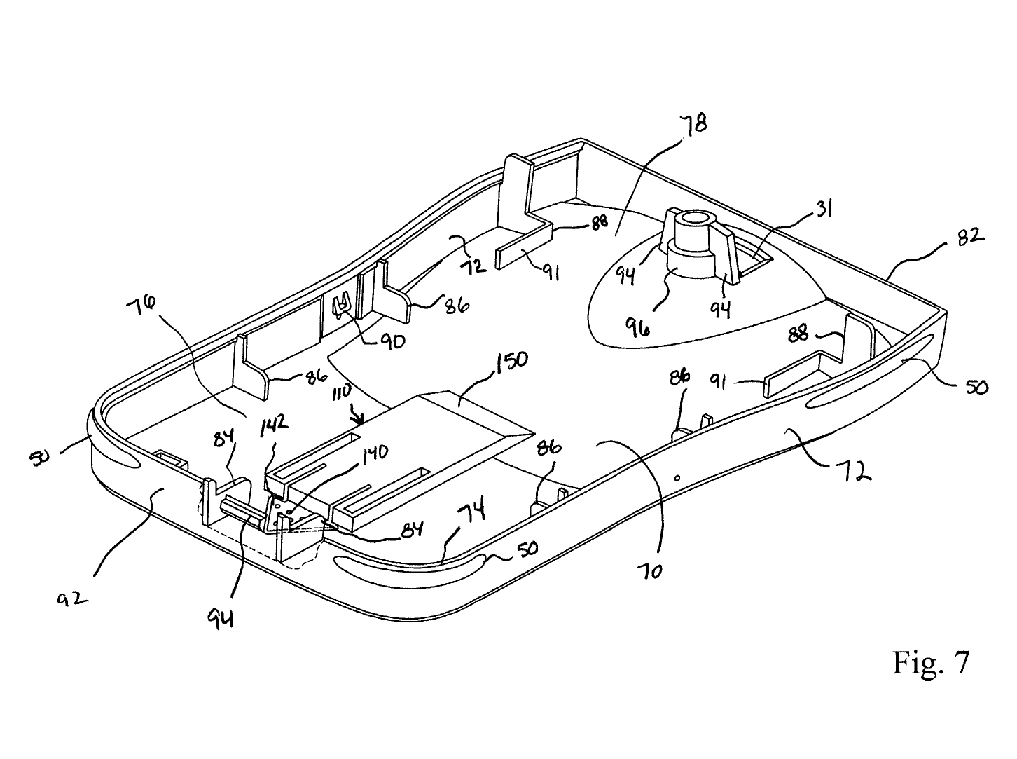

Referring now to FIG. 7, the interior surface of the housing 20 includes forward 84, intermediate 86, and rear 88 pairs of spaced apart, L-shaped, support flanges on opposing lateral sides of the lower support tray 70. These support flanges are formed with an inwardly projecting shelf and an upwardly projecting support along the side walls 72 of the lower half 26. The forward pairing of support flanges 84 are spaced apart along the forward leading edge 32. The intermediate pairings of support flanges 86 are disposed on either side of an inclined retention lip 90 in the form of an inwardly inclined shelf which cooperate with the fastener tabs 58 of the upper half to releasably engage when the two halves 24 and 26 are assembled together.

Positioned rearwardly of the intermediate support flanges are the rear pairs of support flanges 88. The rear support flanges further include a forwardly extending leg 91 providing an additional resting surface for the hardware peripheral 22. All three flange pairings cooperate to form an elevated seat off the interior surface of the lower tray 70 to support the hardware peripheral 22 in a plane substantially parallel to the forward section 76. Supporting the hardware peripheral 22 away from the lower surface of the tray 70 also allows air to flow underneath the peripheral thereby providing an additional area of heat exchange with cooler ambient air and reducing the contact area with the plastic housing. If heat conduction is a significant concern, such support flanges could be manufactured from a more heat resistant material.

The forward wall 92 of the lower half 26 includes a retention hook 94 for complementary receipt of the forward locking tab 68 in the upper half 24. The retention hook projects inwardly from the front wall 92 and is beveled to facilitate a sliding motion of the locking tab over the hook portion to releasably lock together.

Further included in the interior of the lower half 26 is an upwardly projecting female anchor 96 formed with a cylindrical base and a reduced in diameter cylindrical receiver dimensioned to partially received the male anchor 68. The female anchor is positioned within the lower half to align with the male anchor 62 when the two halves 24 and 26 are assembled. A pair of support flanges 94 provides increased structural rigidity to the female anchor 96 and further provides a seat for a portion of hard drive unit 22. It will be appreciated that the anchor feature is optional and is to be used in conjunction with a hardware peripheral having an aperture 97 such as that illustrated in FIGS. 1, 9, and 12.

The upper 24 and lower 26 halves are preferably made from a light weight, semi-rigid polycarbonate or ABS polycarbonate material. Other materials well known in the art are also contemplated. The assembled structure is sufficiently rigid to support a number of stacked peripheral devices. Each half is also sufficiently flexible to allow the fastener elements to releasably engage as will be described below.

Assembly of the housing is a straight forward matter and forms the interior compartment 28 for the hard drive unit 22. Referring now to FIGS. 1 and 6-7, the assembler would first place the lower half 26 on a flat, stable, working surface. The desired electrical component, in this example, such as any of the peripherals 22 having opposing female and male interface connectors 98 and 99 and an anchor aperture 97 mentioned above, is placed on the shelf arm of flanges 84, 86, and 88 as dictated by the size of the drive such that the drive is elevated from the interior surface of the support surface and resists lateral movement due the flanges. The anchor aperture is placed on top of the seat formed by the support flanges 94 of the female anchor.

The top half 24 of the housing 20 is then positioned over the lower half 26 of the housing such that the upper rim 44 is aligned with the similarly contoured lower rim 74 as well as aligning the upper and lower set of fasteners and anchor counterparts 62 and 92. The assembler then presses the upper half 24 onto the lower half until the upper fastener elements 58 and 68 slide over and engage their complementary lower half fastener counterparts 90 and 94 and lock together. It will be appreciated that the male anchor 62 is inserted through the anchor aperture 97 in the hard drive unit 22 and is telescopically received in the female anchor 92. The hardware peripheral is thus sandwiched between the seat of the female anchor 96 and the abutment 66 of the male anchor 62 restricting movement of the hard drive unit 22 in both the vertical and horizontal planes. This assembly process is noticeably easier and faster than using threaded fasteners to secure conventional casings.

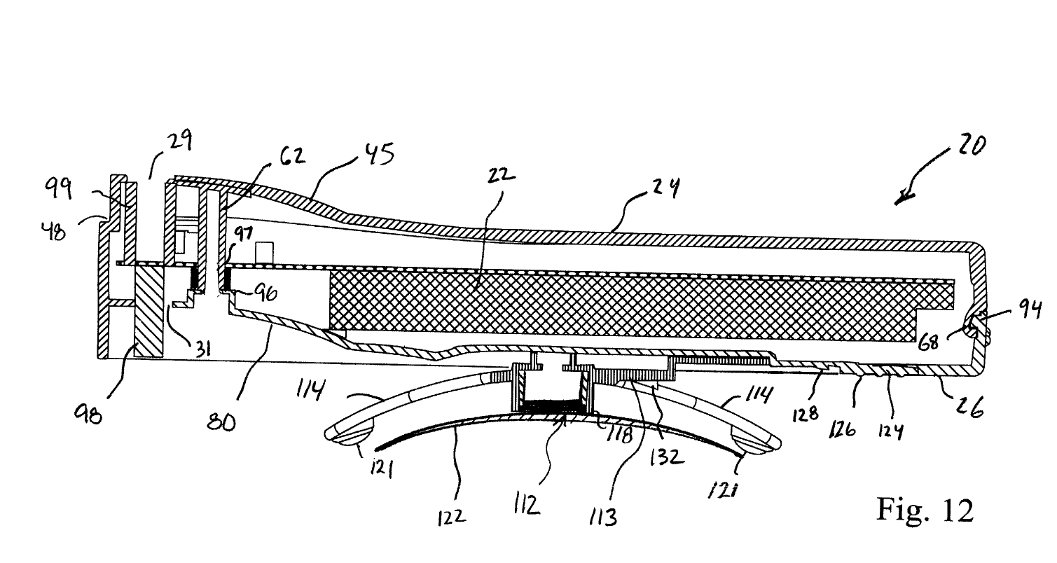

In more detail and referring now to FIGS. 6 and 7, the fastener tab 58 will bend inwardly and slide along the inclined portion of the respective inclined retention lip 90 as the two halves 24 and 26 are pressed together. Once the lower edge of the tabs are past the top flat portion of the retention lip 90, the resilient loop will snap back into vertical alignment and nest against the side wall the lower half 26 with the retention lips 90 residing within the respective fastener receiving slots 60. On the front wall of the respective upper and lower halves the forward locking tab 68 slides over and engages the beveled retention hook 94 to interlock the front end of the housing 20 (FIG. 12).

One of the connectors 98 or 99 of the hard drive unit 22 is then connected to a computer by methods well known in the art, such as internal data line and power cables, so that input and output may be sent from and issued to the drive upon application of power to the unit. The assembled housing, is then placed near a selected processor unit and the interface connector is then connected to the main unit such as a Central Processor Unit as is well known in the art using conventional cables or similar connective means.

With continued reference to FIGS. 6 and 7, it is a simple matter to disassemble the housing 20. Initially, the connectors 98 and 99 must be disconnected from any other peripherals or computers. The flexibility of the housing enables the disassembler to merely push inwardly on the upper half 24 near each of the fasteners 58 and 68. The respective tab 58 or 68 will be forced off of its respective lower half 26 fastener counterpart 90 or 94 to disengage the complementary fasteners. Once this is done at each fastener mating, the halves 24 and 26 may be separated and the male anchor 62 slidably disengaged from the female anchor 96. The drive 22 can be removed from the lower support tray 70 and a new peripheral may then be placed within the tray to prepare for the next assembly operation if desired.

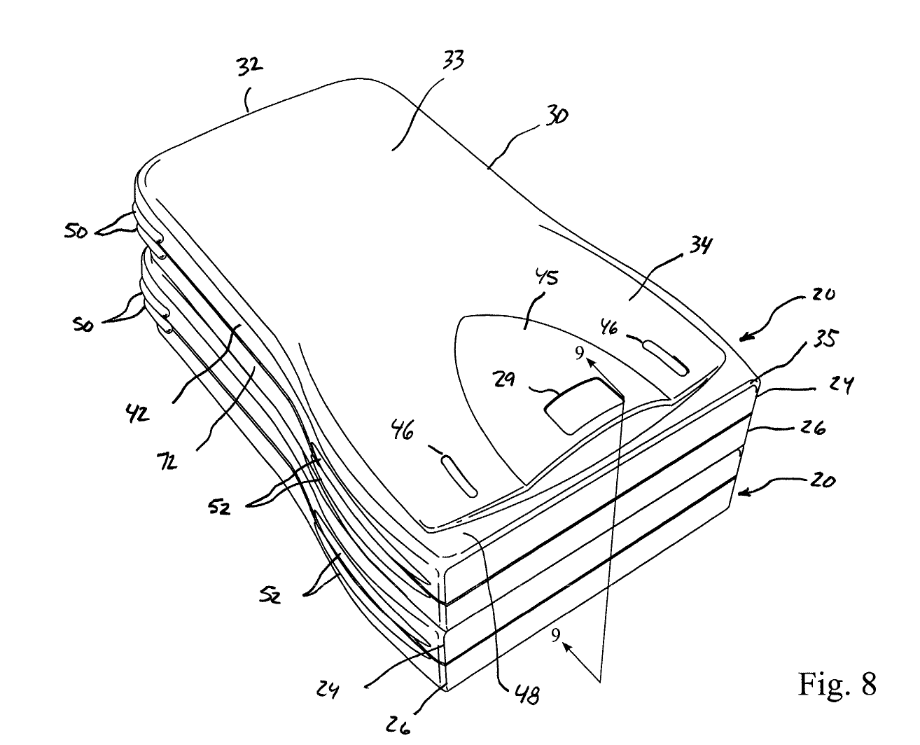

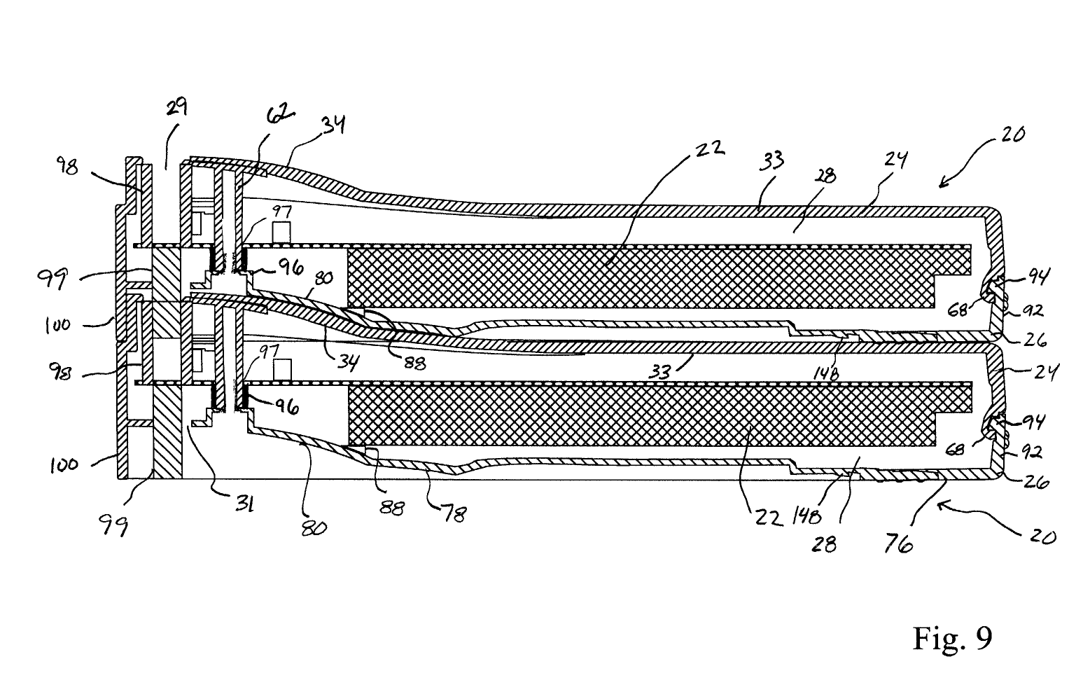

Referring now to FIGS. 8 and 9, it will further be appreciated that the complementary top and bottom surfaces of the housing 20 advantageously lends itself to a multiple housing stacking arrangement with adjacent surfaces being flush in relation to one another thus reducing the overall height of the stack. The complementary nature of the top and bottom surfaces in rear portion of each half is illustrated in FIGS. 4-5 and 9. Such stacking arrangement further allows a series of male to female complementary interface connectors to be aligned and mated such that multiple hard drive units 22 may be arranged in a hot swappable configuration wherein individual housings and units in a stack may be removed and added without requiring a reboot of the computer system. In addition, no cables are required as the male and female interface connectors 98 and 99 may be directly connected together because of the top half dome 45 and inverted dome 80 configuration.

Each of the connectors 98 and 99 includes at least one end in electrical communication with its respective hardware peripheral 22 such that signal and power flow may be routed between each connector and the hardware peripheral. In addition male and female connectors transmit signal and power between one another. Thus, mated connectors form a connection chain such that one end of the stacked hardware configuration may be connected to a computer and each individual hardware peripheral is capable of receiving and transmitting signals and power to other hardware peripherals in the stack or to the main computer.

Additional housings 20 may be stacked in the following manner. A first assembled housing may be placed on a planar working surface. Subsequent housings are placed upon a lower housing by nesting the lower half 26 of an adjacent housing 20 with the upper half 24 of an immediate underlying housing. It will be appreciated that the planar forward portions of the respective upper and lower halves and the rear connector sections of the respective upper and lower halves will nest directly against one another due to the complementary surface construction. The rigid plastic housing is constructed sufficiently strong to support multiple housings. As illustrated in FIG. 9, at least a portion of the male connector 99 is inserted into the female connector 98 directly below in the stacked configuration. Thus, a multiple hard drive unit 22 stacked assembly may be configured provide a more closely stacked arrangement without the use of additional cable lines to connect the peripherals together.

Referring now to FIG. 9, the back wall of the lower half 26 includes an extension 100 which is telescopically received over the rear wall of the top half 24 and is stopped in its downward travel by the step 48. This allows the male connector 99 projection to be inserted into the female connector 98 of an adjacent housing 20 and further facilitates a flush nesting of the adjacent housing surfaces.

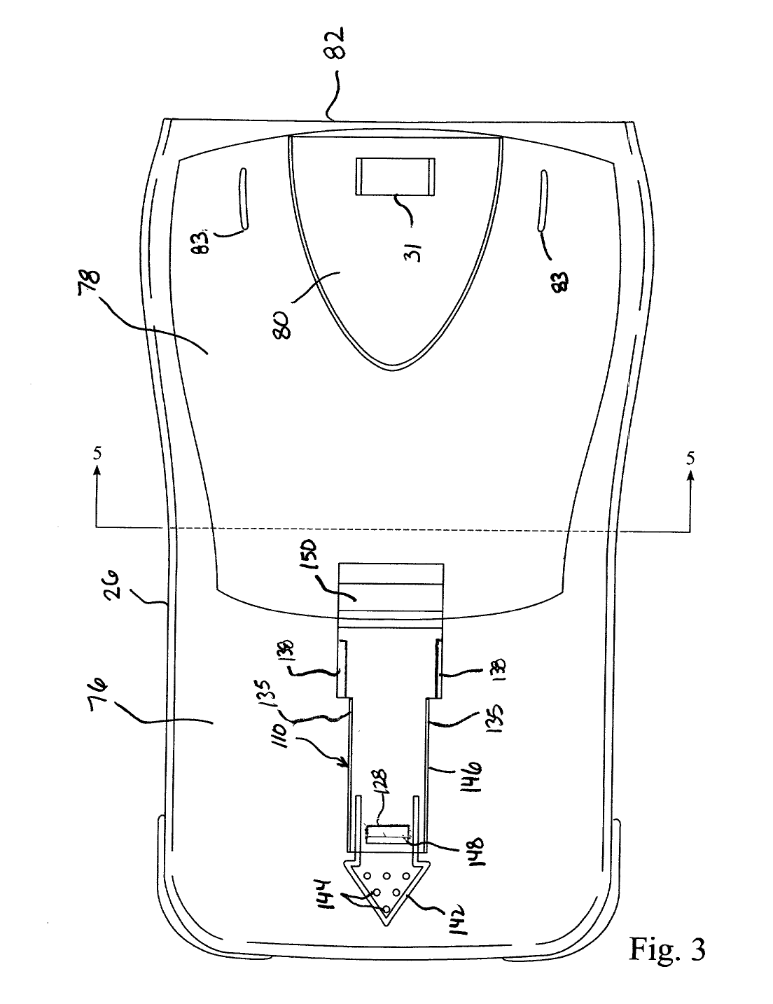

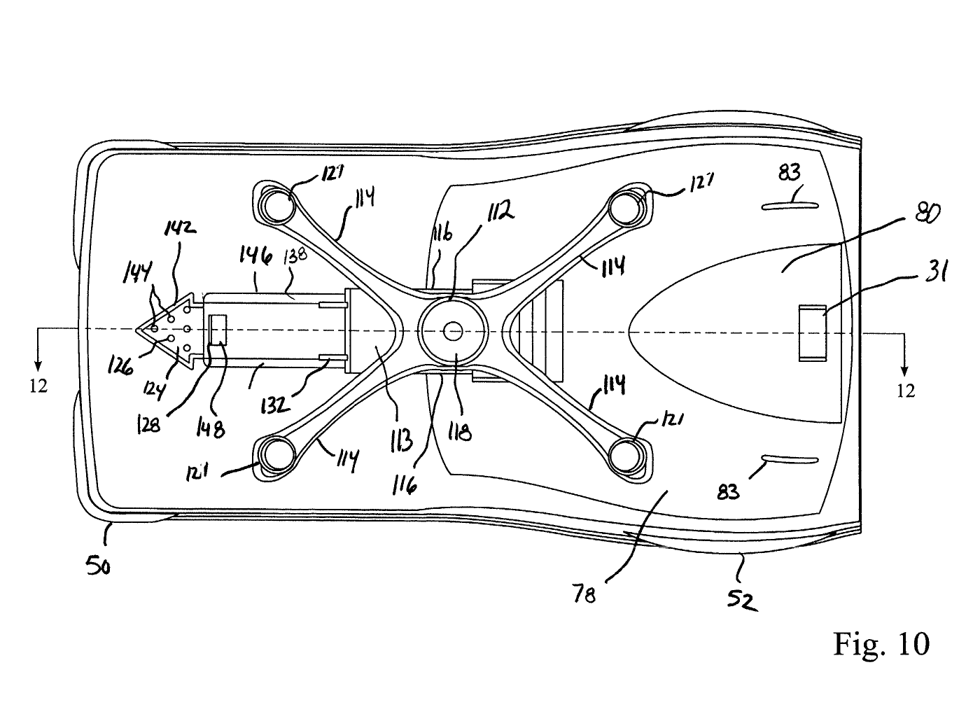

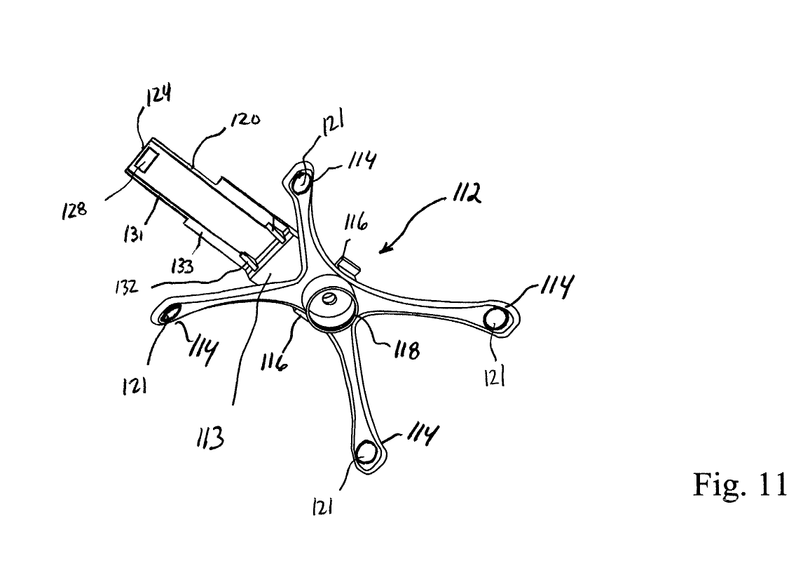

Referring now to FIGS. 3, 7 and 10-12, another feature of the present invention is illustrated. The housing 20 may include an accessory clip, generally designated 110 for use with a support stand attachment 112 (FIG. 11). With specific reference to FIG. 11, the support attachment 112 generally includes a base 113, a set of four legs 114, a pair of opposing lateral stabilizer flanges 116, a hollow cylindrical stub 118, a male prong 120, and a suction cup 122 attached to the stub 118 (FIG. 12). As illustrated in FIGS. 10 and 12, the resilient legs 114 may terminate in a pad 122 to provide additional shock mounting for the casing and internal hardware. The suction cup 122 facilitates placement of planar surface whether level or inclined such as the back of a laptop computer. Such placement is advantageous where space is a precious commodity such as the serving tray in an airplane seat. It is a simple procedure to attach the support stand 112 to the housing 20 and press the suction cup 122 against the back side of a lap top until it adheres such that no additional tray space is required for the hardware peripheral. The suction cup 122 further acts as a shock reducer.

The male prong 120 includes at its distal extremity a rectangularly shaped neck 124 with a connector slot 128. Along the outside edge of the neck 124 is a pair of increased in width flanges 131 and 133 that slide beneath respective retention lips 135 and 138 on the underneath surface of the housing 20. A pair of opposing inclined supports 132 attaches to the base of the neck to the support base 113 and adds strength to the connection.

Referring now to FIG. 7, the lower half 26 of the housing 20 includes the accessory retention slot 110 includes a resilient female release tab 140 that is complementary shaped to the male prong 120. The female release tab includes a triangular head 142 having a series of six knobs 144 to facilitate pushing the release tab 140. Adjacent the release tab is a locking flange 148. A ramp 150 at the interior end of the locking tab 140 assists in guiding the male prong 120 into the female locking tab area. By depressing the release tab 140, the locking flange 148 may be pushed clear of the locking slot 128 such that an accessory clip may then be slid clear of the retention slot 110.

To attach the accessory stand 112 to the lower half of the housing 20, the neck 124 is guided along the ramp 150 into the lower half 26 of the housing. The flanges 131 and 133 are slid beneath the retention lips 135 and 138 until the locking tab 148 snaps into place in the locking slot 148 and nests therein. The base 113 of the accessory stand 112 will rest up against the underneath of the lower half 26 exterior surface and the stabilizer flanges 116 inhibit rotation of the housing 20 in relation to the support stand 112. The stabilizer flanges 116 may also be received beneath a flange on the lower surface of the housing to provide additional structural integrity to the connector housing configuration. Such attachment may be employed in a variety of uses and the legs may be formed to fit the desired situation.

Referring now to FIGS. 13 and 14, another accessory that may be used is the belt clip, generally designated 200. The belt clip 200 includes a retention flange 202 similarly constructed to the neck 120 of the accessory clip 112 and a belt hook 204 and like components are like numbered. The belt hook 204 includes a long shank 205 terminating at one end in a curved end 206 for placement over of belt or other adequate piece of apparel. The belt hook 204 is pivotally connected to the neck 120 and includes a pivot pin 206 and a resilient metal insert placed on the interior between the neck 120 and a lever 208. The belt clip 200 may be inserted into the bottom surface of a housing as described above for the accessory foot 112. After locking the belt clip in place the housing may be work on a belt or similar item of clothing thus significantly increasing the transportability of the housing and its internal hardware.

The above-described invention provides advantages of a light weight, easy to assemble, modular, stackable unit that may omit the use of a cooling fan and permits a nestable stacking configuration to remove the requirement of interface cables by providing upper and lower access ports to the internal interface connectors in electrical communication with the hardware peripheral. The housing could alternatively be dimensioned to function as a housing for a personal computer or Internet access box, whereby a plurality of components such as motherboards, hard drives, CD-ROM drives, modems, and other conventional components could all be contained within the housing described herein. Other electrical devices such as stereos, CD-players, VCR's and related components could also easily be accommodated by the snap together housing embodied in the figures.

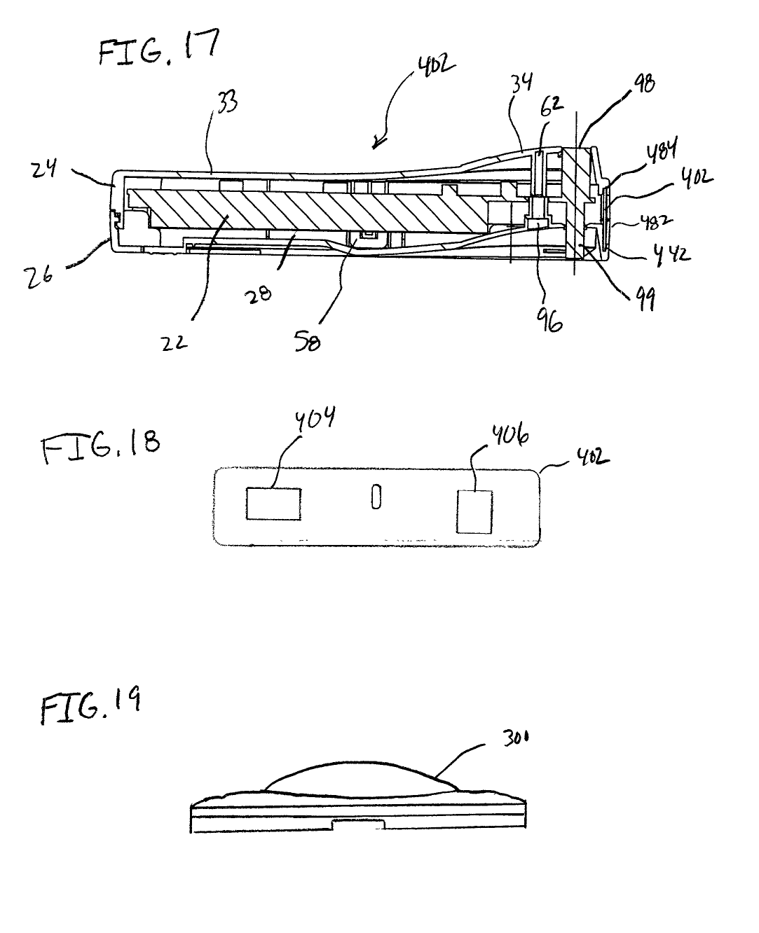

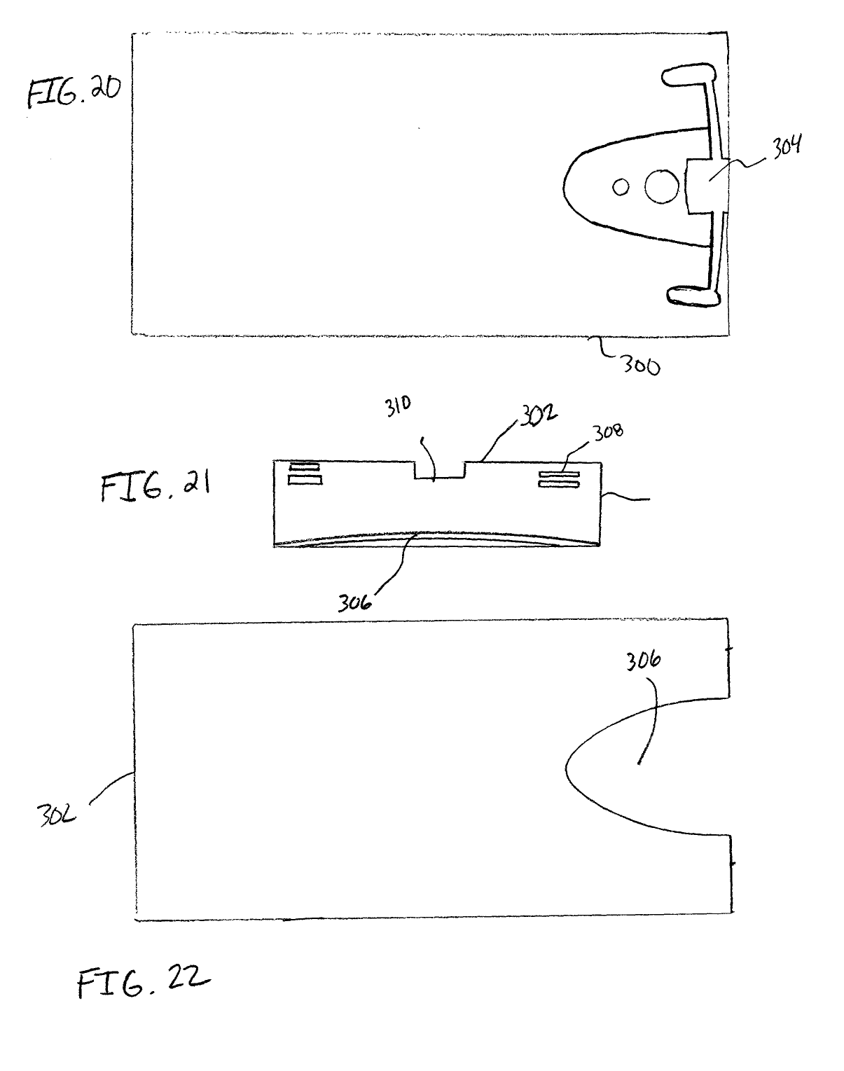

Referring now to FIGS. 19-22, in some situations additional shock mounting may be desired. To provide this additional shock mounting, a thin, lightweight, metallic shell insert having an upper half 300 and a lower half 302 which are formed to be inserted between the interior of the respective halves 24 and 26 of the housing 20 and the hardware device contained therein. The upper and lower half includes tabs (not shown) and slots 308 to lock them together around the hardware unit. The top half insert 300 includes a cutout section 304 to enable access to the interface connector of the hardware device. The bottom half insert 302 includes a cutout 306 allowing access to the lower interface connector of the hardware device. A forward ledge 310 is provided for a section of the hardware unit to rest upon. Both shells are formed to closely resemble the interior of the respective half of the housing 20. The shell may be used with the supports 54 and seats 84, 86, and 88 of the halves 24 and 26 or may be used alone. The shell further provides a heat sink for the hardware unit inside and shields the hardware unit from electromagnetic fields from external devices.

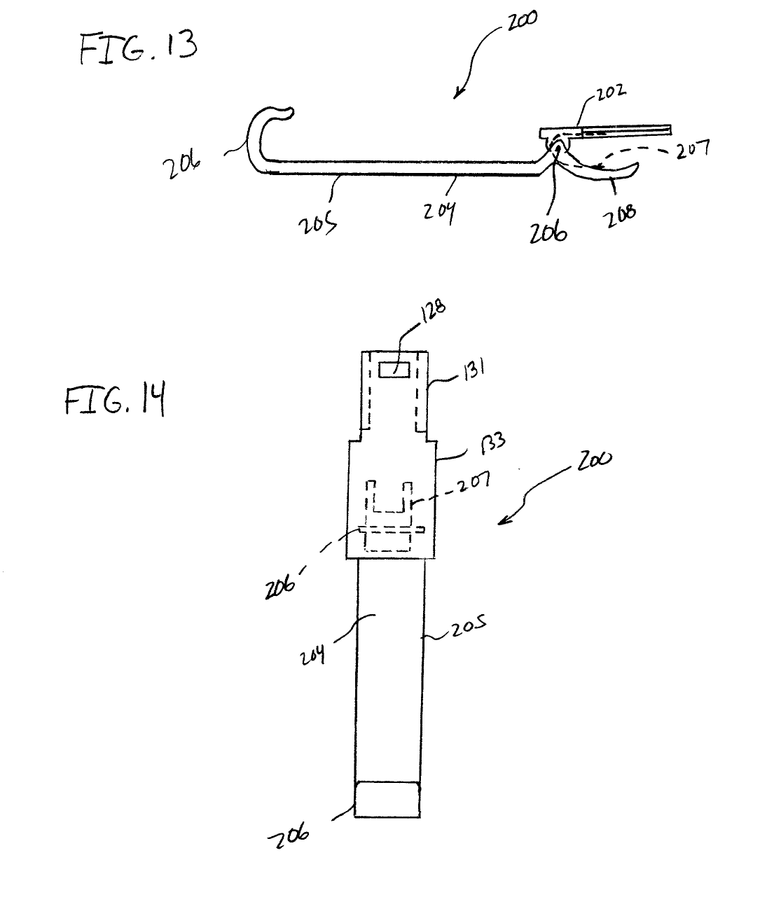

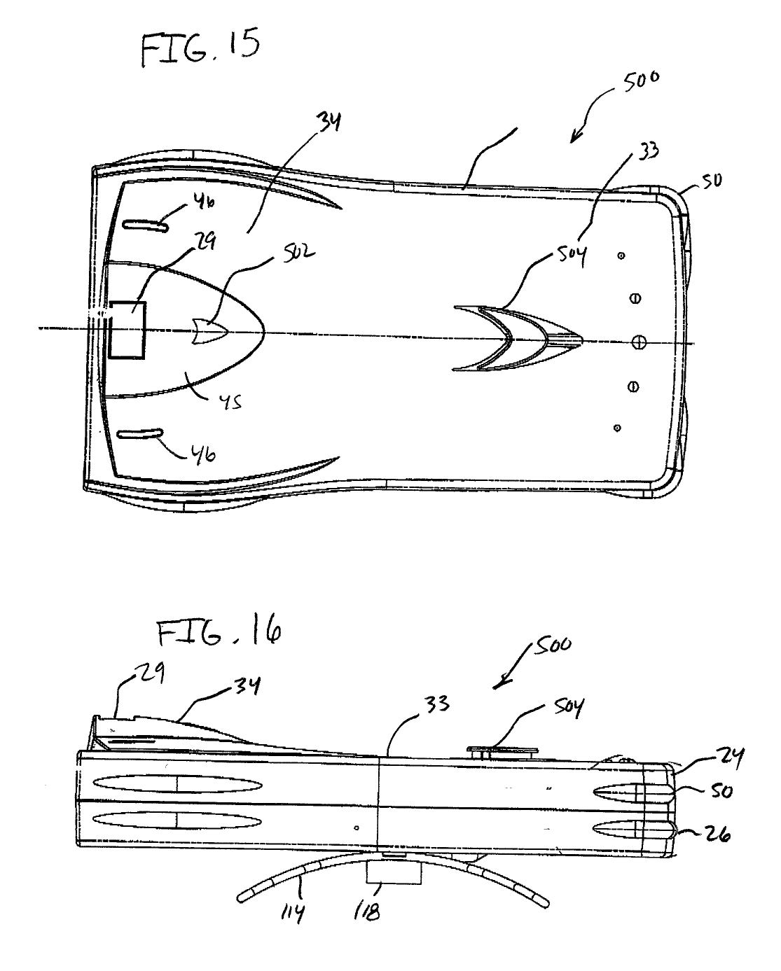

Referring now to FIGS. 17 and 18, an alternative embodiment of the housing, generally designated 400, is illustrated wherein like components are like numbered. The housing incorporates a rear interface panel 402 (FIG. 18). Such rear interface panel 402 may be constructed as described in co-pending U.S. Ser. No. ______ , entitled Modular External Peripheral Housing, filed on Nov. 13, 2000 which is hereby incorporated by reference in its entirety. In addition to those configurations described in U.S. Ser. No. ______ , the interface panel 402 may also include a 1394 connector slot 404 and a power supply slot 406.

It will further be understood that the present invention is not limited to a particular platform such as the Macintosh, Windows, or UNIX systems. In addition, the access slots may be constructed to accommodate any connector well known in the art and is not limited by the examples provided herein. It will also be appreciated that alternative fasteners configured for releasable engagement as are well known in the art such as snaps or clips are also contemplated and would be within the scope of the present invention. The number of fasteners and locations could also be modified without detracting from the scope of the present invention.

Located in the rear portion of the upper half is a pair of vertically projecting upper tracks 484. The tracks are situated on opposite sides and each track includes a vertical slot dimensioned to receive an edge of the interface panel 402. A transversely running groove for receipt of the upper edge of the interface panel may also be incorporated for additional restraint of the interface panel.

Near the trailing edge 482 of the lower tray 26 is a set of opposed lower tracks 442 separated by a transverse lower groove recessed into the interior surface of the lower tray to receive the lower edge of the interface panel 402. This lower groove is substantially parallel to the upper groove on the upper half when the two halves are assembled together. The lower tracks are positioned within the lower tray to align with the respective upper tracks 484 on the upper half 24 of the housing 20 upon mating engagement of the two halves.

Referring to FIGS. 5-6, a rectangular, exchangeable, interface panel 402 is provided to carry an array of interface connectors and devices that transfer data to and from the drive 22 mounted in the compartment 28. The panel or plate is dimensioned on its vertical edges to slidingly fit within the upper 484 and lower 442 tracks. The upper and lower edges of the interface panel are constructed to fit with the respective upper and lower grooves. When the interface panel is within the housing halves it is clamp fitted into place and is not removable until the halves are disassembled. It will be appreciated that a variety of panel shapes could be used without detracting from the scope of the present invention.

An array of openings is set within the interface panel 402. The openings are generally shaped and sized to accommodate various connectors and other components required to provide power of other indications of activity within the drive 22. Because the present invention is designed to be flexible, rear interface panels may include different arrays of openings for use in conjunction with a particular model drive. For purposes of illustration, but not in any way limited to, the interface panel may include openings generally for a Small Computer System Interface (SCSI) input port and output port. An additional switch opening may be provided provided for a component such as a slide switch (not shown) to power on a power supply. Other openings for connectors such as a Universal Serial Bus port, parallel port, PC card slot, or LED openings may be substituted for as necessary. The interface panel is in no way restricted from accommodating the wide variety of connector, power, or indicator options known in the art. Additional openings may also be provided to accommodate fasteners for the various connector devices. In addition to those configurations described in U.S. Ser. No. ______ , the interface panel 402 may also include a 1394 connector slot 404 and a power supply slot 406 (FIG. 18).

The interface panel is preferably formed from a metallic material and the various openings may be stamped out by methods well known in the art. The compressive resistance of the interface panel supports the rear end of the housing 20. While the tracks and rectangular panel configuration accommodate a quick and easy interchange of interface panels, other means could be used to releasably engage the interface panel with the housing.

A preselected rear interface panel 402, having been stamped and fitted with the desired interface components (not shown), is then slidably inserted into the vertical lower tracks 442 in the lower half 26 near the rear edge (FIG. 11). The bottom edge of the panel is nested within the transverse groove. The peripheral 22 is then connected to the interface panel by methods well known in the art, such as internal cables, so that input and output may be sent from and issued to the drive upon further connection to a processor. A power supply is also connected to between the drive and the panel.

The top half 24 of the housing 20 is then positioned over the lower half of the housing such that the upper tracks 484 slidably engage the vertical upper edges of the interface panel 402. The upper half continues to slide onto the interface panel until the first fastener element is aligned with the second fastener element and the lower edge abuts the complementary upper rim. The two halves are then pressed together until the fastener elements lock together. This process is noticeably easier and faster than using threaded fasteners to secure conventional casings.

The rear access opening is generally occupied by the rear interface panel so that connections may be made from the drive to a processor or other device. Such interchangeable rear interface panel is described in U.S. Pat. No. 6,147,859, and co-pending application entitled, Modular External Peripheral Housing, filed on Nov. 13, 2000.

Another alternative housing embodiment, generally designated 500, is illustrated in FIGS. 15 and 16 wherein like components are like numbered. Such housing 500 includes a triangularly shaped window 502 through which an LED may signal status of the hardware unit inside or alternatively receive infrared signals from a remote device to transmit signals to the hardware device inside the housing 500. A forward locking hook 504 includes a raised and outwardly flanged section that may snap into the channel in the lower surface of the lower half 26 of an adjacent housing thus providing additional resistance to prevent the housings from sliding in relation to one another.

It will be appreciated that the housing embodiments described herein, provide a portable, shock mounted, hands free, stackable peripheral that may be mounted to any planar surface and may be used in a variety of environments including desktop, laptop, network computers, as well as in conjunction with digital data generating devices such as digital camcorders. The devices may constructed to accommodate wireless communication and also enclosed such devices as MP3 or audio file players. The housing provides a versatile, portable data storage device by encasing a hard drive that is readily adaptable to a variety of industries including but not limited to the medical industry to store digital images or the entertainment industry to store multimedia files or other storage data. The housing may also be rack mounted as an exchangeable peripheral.

While several forms of the present invention have been illustrated and described, it will also be apparent that various modifications may be made without departing from the spirit and scope of the invention.

What is claimed is:

1. A housing for a hard disk drive unit including a circuit board having first and second complementary connectors projecting outwardly from the circuit board, said housing comprising:
an upper half having a top portion flanked by a pair of downwardly projecting side walls including a first fastener element, said upper half including a front portion and an upwardly raised rear connector section forming an arcuate surface, when viewed in transverse cross section, said arcuate surface further defining a slot for receipt of a first connector;
a lower half configured with a support surface for resting said hard disk drive unit thereon and adjoined to a pair of upwardly projecting side walls including a second fastener element configured for releasable engagement with said first fastener element, said lower half further including a recessed section configured to complement and nest against said raised section of an adjacent housing when two or more housings are placed in a stacked relationship, said recessed section further including an aperture for receipt of a second connector; and
wherein said halves cooperate when said fastener elements are releasably engaged to form an interior compartment for receipt of the hard disk drive unit and said slot is aligned with said first connector and said aperture is aligned with said second connector.

2. The housing as set forth in claim 1 wherein:
said connector section is substantially semi-elliptically shaped and said recessed section is complementally shaped to nest thereon when adjacent housings are placed in a stacked relationship.

3. The housing as set forth in claim 1 wherein:
said upper half includes a rear wall having a step and said lower half includes a complementally formed lip for slidingly engaging and complementally nesting against said step of an adjacently stacked housing.

4. The housing as set forth in claim 1 wherein:
said upper half side walls terminate in a lower rim;
said lower half wall terminate in an upper rim; and
wherein said rims engage in an abutting relationship upon assembly of said havles together.

5. The housing as set forth in claim 1 wherein:
said first fastener element includes at least one laterally disposed channel shaped retainer; and
said second fastener element includes a resilient, inclined retention lip for slidable engagement with said first fastener element.

6. The housing as set forth in claim 1 wherein:
said support surface includes a recessed accessory retention slot.

7. The housing as set forth in claim 6 wherein:
said retention slot includes a resilient release tab.

8. The housing as set forth in claim 7 wherein:
said release tab is triangularly shaped.

9. The housing as set forth in claim 6 further including:
a foot stand having an attachment member for complemental insertion into said retention slot.

10. The housing as set forth in claim 9 wherein:
said foot stand includes a plurality of flexible feet and a central outwardly facing suction pad for attachment to a flat surface.

11. The housing as set forth in claim 1 wherein:
the interior surface of said support surface includes a plurality of support flanges forming a seat for resting the hard disk drive unit thereon.

12. The housing as set forth in claim 1 further including:
a first circuit board anchor extending downwardly from said top portion;
a second circuit board anchor extending upwardly from said support surface; and
wherein said anchors may be inserted into an aperture in said circuit board and releasably engaged together to inhibit movement of the circuit board within the housing when said halves are engaged.

13. The housing as set forth in claim 1 wherein:
said halves are constructed of a rigid plastic material.

14. The housing as set forth in claim 1 wherein:
said upper and lower halves includes a track in their respective rear walls for receipt of a removable interface panel.

15. The housing as set forth in claim 6 further including:
a belt clip including an insert for releasable connection to said accessory retention slot.

16. A housing for encasing a hardware peripheral including a circuit board extension with opposing male and female connectors and a locking aperture comprising:
a rigid top half including a contoured upper surface extending laterally to terminate in downwardly extending sidewalls, said upper surface including a substantially planar forward section and an adjacent rearward section having a raised area with an arcuate cross section when viewed in lateral cross section and defining a female connector port to be positioned over said circuit board extension;
a first locking element projecting inwardly from said upper surface;
a first fastener attached to said downwardly extending sidewalls;
a rigid bottom half including a holding tray formed with a seating arrangement for placement of said hardware peripheral thereon, said tray extending laterally to terminate in upwardly extending sidewalls, said tray including a contoured lower surface complementing said upper surface and defining a male connector port to be positioned under said circuit board extension;
a second fastener attached to said upwardly extending sidewalls for complemental releasable receipt of said first fastener when said halves engage;
a second locking element projecting upwardly from said lower surface for complemental releasable receipt of said first locking element when said halves engage and forming a shelf for said circuit board extension to rest thereon; and
wherein said halves cooperate when releasably engaged to form an interior compartment for receipt of the hardware peripheral and align said female connector port and said male connector port with their respective connectors.

17. A method of stacking peripheral housings comprising the steps of:
providing a first housing including an upper surface having a first contoured section defining an upwardly opening connector slot;
providing a second housing including a lower surface having a second contoured surface complementary to said first contoured surface and including a downwardly opening second connector slot;
placing said first housing on a desired work surface to orient said upper surface in a substantially horizontal plane to said work surface;
placing said second housing on top of said first housing to nest said contoured surfaces together and align said upwardly opening connector slot of said first housing with said downwardly opening connector slot of said second housing.

18. A stackable housing encasing a computer peripheral device comprising:
an upper half having top portion flanked by a pair of downwardly projecting side walls having a first fastener element, said upper half including a raised section having a slot;
a lower half configured with a lower support surface adjoined to a pair of upwardly projecting side walls having a second fastener element configured for releasable engagement with said first fastener element, said lower half further including a recessed section configured to complement said raised section and having an aperture;
a computer peripheral mounted in said lower half and covered by said upper half;
a printed circuit board extending from said computer peripheral and including opposing sides;
a male connector projecting from one side of said printed circuit board and extending through said aperture;
a female connector projecting from an opposing side of said printed circuit board and aligned with said slot; and
wherein said halves cooperate when engaged to form an interior compartment for receipt of said computer peripheral and additional housings may be stacked upon one another in vertical alignment to connect a male connector to an adjacent female connector.
